(19) United States
(12) Patent Application Publication
(10) Pub. No.: US 2006/0288215 A1
(43) Pub. Date: Dec. 21, 2006

(54) Methods and apparatuses for utilizing application authorization data

(76) Inventors: Shinichi Takemura, Kanagawa (JP); Geoffrey Levand, Mountain View, CA (US); Zhengrong Liu, Foster City, CA (US)

Correspondence Address: Richard H. Butler, 5655 Silver Creek Valley Road, # 106, San Jose, CA, 95138, US

(21) Appl. No.: 11/154,057

(22) Filed: Jun. 15, 2005

(51) Int. Cl. H04L 9/00

(52) U.S. Cl. 713/175

(57) ABSTRACT

In one embodiment, the methods and apparatuses embed a first application authorization data within a target application wherein the first application authorization data corresponds with encrypted information; detect a second application authorization data; and compare the first application authorization data with the second application authorization data; and selectively decrypt the encrypted information within the target application based on the comparing.

### FIELD OF INVENTION

The present invention relates generally to utilizing application authorization data and, more particularly, to utilizing application authorization data through a library.

### BACKGROUND

A common mechanism to protect sensitive information is to encrypt the information with a secret. By encrypting the information with the secret, unauthorized devices that do not have access to the secret are unable to access the encrypted information.

To access and utilize the encrypted information, the secret is utilized to decrypt the encrypted information. Once the encrypted information is decrypted, this information is available to the device. Controlling access to the secret such that only authorized devices can access the secret helps prevent unauthorized access to the encrypted information.

It is desirable to limit access to the secret to prevent unauthorized target applications from gaining access to the encrypted information.

### SUMMARY

In one embodiment, the methods and apparatuses embed a first application authorization data within a target application wherein the first application authorization data corresponds with encrypted information; detect a second application authorization data; and compare the first application authorization data with the second application authorization data; and selectively decrypt the encrypted information within the target application based on the comparing.

### BRIEF DESCRIPTION OF THE DRAWINGS

The accompanying drawings, which are incorporated in and constitute a part of this specification, illustrate and explain one embodiment of the methods and apparatuses for utilizing application authorization data. In the drawings,

FIG. 1 is a diagram illustrating an environment within which the methods and apparatuses for utilizing application authorization data are implemented;

FIG. 2 is a simplified block diagram illustrating one embodiment in which the methods and apparatuses for utilizing application authorization data are implemented;

FIG. 3 is a simplified block diagram illustrating a system, consistent with one embodiment of the methods and apparatuses for utilizing application authorization data;

FIG. 4 is an exemplary record for use with the methods and apparatuses for utilizing application authorization data;

FIG. 5 is an exemplary record for use with the methods and apparatuses for utilizing application authorization data; and

FIG. 6 is a flow diagram consistent with one embodiment of the methods and apparatuses for utilizing application authorization data.

### DETAILED DESCRIPTION

The following detailed description of the methods and apparatuses for utilizing application authorization data refers to the accompanying drawings. The detailed description is not intended to limit the methods and apparatuses for utilizing application authorization data. Instead, the scope of the methods and apparatuses for utilizing application authorization data are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, and a device capable of receiving/transmitting an electronic message.

References to a “target application” include an application running on a device. In one embodiment, the target application is identified as a particular application running on a particular device such as an image processing application running on a particular digital camera identified by the unique serial number of the particular digital camera. In another embodiment, the target application is identified as an application running on a class of devices such as an image processing application running only on Sony Digital Cameras.

References to “encrypted information” include encrypted content such as documents, audio streams, visual representations, software code, and other electronic representations.

References to “encrypted secret” include encrypted key that is utilized to unlock the encrypted information and allow the encrypted information to be utilized by the target application.

In one embodiment, the methods and apparatuses for utilizing application authorization embed the application authorization data within a target application. In one embodiment, the authorization application data corresponds with encrypted information and an encrypted secret. To gain access to the encrypted information data, the target application matches the embedded application authorization data with the application authorization data included in the encrypted secret. In one embodiment, the encrypted information is decrypted and made available to the target application when the application authorization data embedded within the target application is authenticated.

For example, the encrypted information corresponds with a particular application authorization data. When the application authorization data that is embedded within the target application is confirmed to match this particular application authorization data that corresponds with the encrypted information, then this encrypted information is made available to the target application.

In one embodiment, the encrypted information corresponds to a library that allows multiple application authorization data wherein each application authorization data corresponds to a unique target application. For example, each application authorization data corresponding to the library is associated with a unique digital camera as the target application. In one embodiment, this encrypted information is made available to target applications that are embedded with application authorization data that corresponds to the encrypted information.

In another embodiment, each application authorization data corresponding to the library is associated with a class of target applications. For example, each application authorization data corresponding to the library is associated with a unique brand of digital camera as the target application.

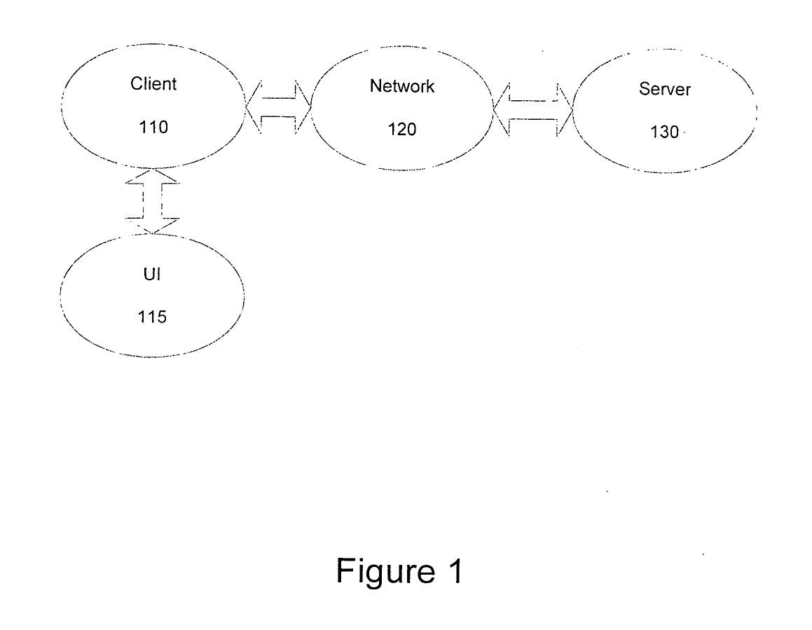

FIG. 1 is a diagram illustrating an environment within which the methods and apparatuses for utilizing application authorization data are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of utilizing application authorization data related to an event below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

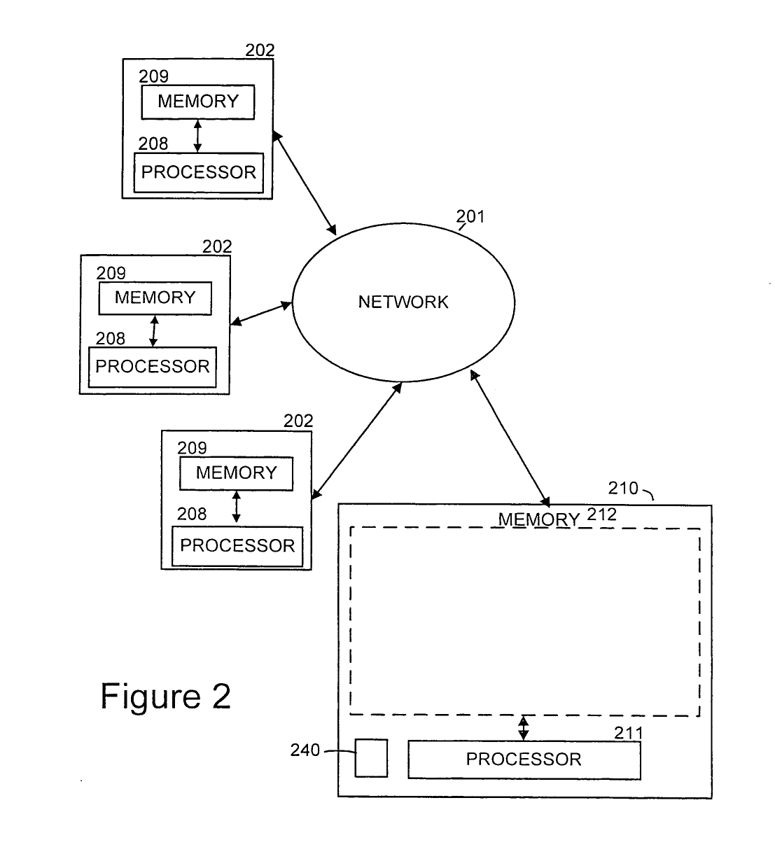

FIG. 2 is a simplified diagram illustrating an exemplary architecture in which the methods and apparatuses for utilizing application authorization data are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for utilizing application authorization data. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on utilizing application authorization data as determined using embodiments described below.

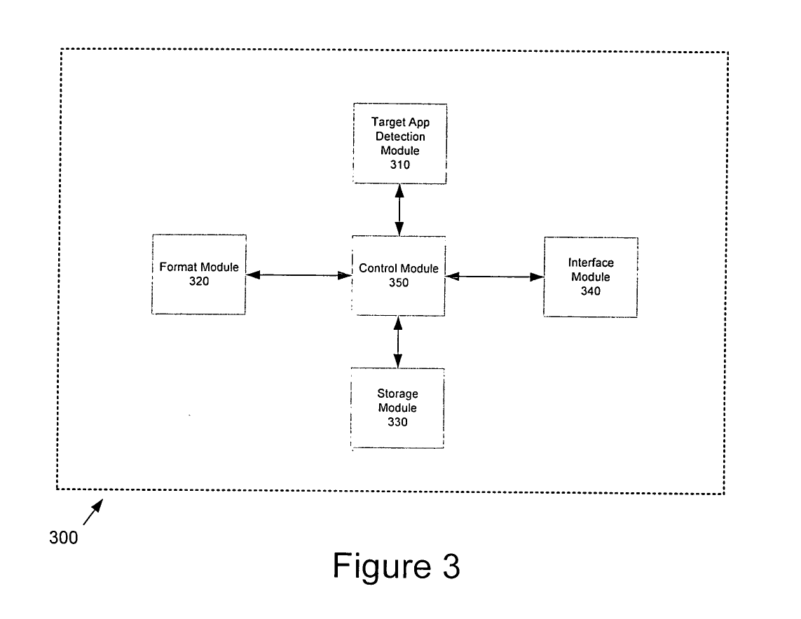

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a target application detection module 310, a format module 320, a storage module 330, an interface module 340, and a control module 350.

In one embodiment, the control module 350 communicates with the target application detection module 310, the format module 320, the storage module 330, and the interface module 340. In one embodiment, the control module 350 coordinates tasks, requests, and communications between the target application detection module 310, the format module 320, the storage module 330, and the interface module 340.

In one embodiment, the target application detection module 310 detects the selected target applications that are authorized to access the encrypted information. In one embodiment, the target application detection module 310 detects the application authorization data that resides within the executable (e.g. in the executable and linking format (ELF) file within the authorized target application). In one embodiment, the target application detection module 310 verifies the authenticity of the application authorization data and that the application authorization data corresponds with the encrypted information.

In one embodiment, the target application detection module 310 selectively allows access to the secrets to decrypt the encrypted information based on the application authorization data within the target application. Without access to the secrets, the target application cannot decrypt the encrypted information.

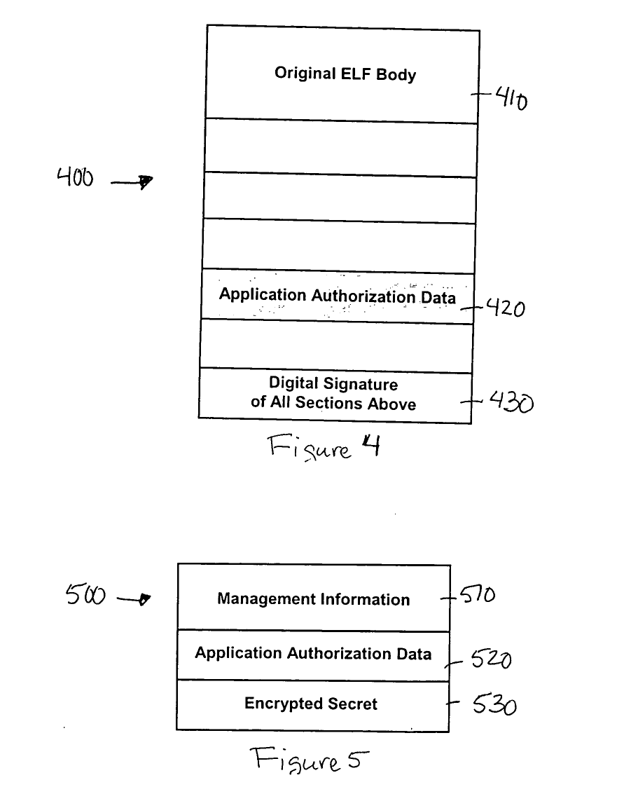

In one embodiment, the format module 320 forms the application authorization data within the executable and linking format (ELF). An exemplary record representing the executable and linking format with the application authorization data is shown in FIG. 4. Although the executable and linking format is shown in these examples, the invention may utilize a variety of file structures.

In one embodiment, the storage module 330 stores a record including application authorization data. For example, the application authorization data that is configured to be embedded within a target application is illustrated within the record 400 in FIG. 4. In another example, the application authorization data and the encrypted secret are illustrated within the record 500 in FIG. 5.

In one embodiment, the interface module 340 receives a signal from one of the electronic devices 110 indicating a request to utilize the encrypted information on a target application. In another embodiment, the interface module 340 delivers a signal to one of the electronic devices 110 indicating authorization to make the encrypted information available to the target application based on matching the application authorization data embedded within the target device and the application authorization data corresponding with the encrypted information.

The system 300 in FIG. 3 is shown for exemplary purposes and is merely one embodiment of the methods and apparatuses for utilizing the application authorization data. Additional modules may be added to the system 300 without departing from the scope of the methods and apparatuses for reviewing general public licenses. Similarly, modules may be combined or deleted without departing from the scope of the methods and apparatuses for utilizing the application authorization data.

FIG. 4 illustrates an exemplary record 400 for incorporating the application authorization data within the executable and linking format.

In one embodiment, there are multiple records such that each record 400 is associated with a unique encryption key and secret. In one embodiment, the record 400 includes an original executable and linking format field 410, an application authorization data field 420, and a digital signature field 430.

In one embodiment, the record 400 resides within a target application. In use, the application authorization data field 420 within the target application includes application authorization data that corresponds with application authorization data within the encrypted information. In one embodiment, the encrypted information is decrypted when the application authorization data within the target application matches the application authorization data.

In one embodiment, the application authorization data field 420 is configured as a static value. For example, as the target application changes through updates and modifications, the application authorization data field 420 remains the same.

In one embodiment, there are multiple records 400 associated with a particular target application. In this example, the particular target application is capable of decrypting information that is encrypted from different sources with different encryption keys and secrets.

In one embodiment, by utilizing multiple records for a particular target application, access to encrypted information is controlled by limiting access to decrypting the encrypted information and freely distributing the encrypted information.

For example, target application A includes application authorization data for secrets X and Y. Further, target application B includes application authorization data for secret X. In this example, encrypted information C requires secret X to decrypt, and encrypted information D requires secret Y to decrypt. Encrypted information C and encrypted information D are both made available to target application A and target application B. In this example, target application A is capable of decrypting encrypted information C and encrypted information D while target application B is only capable of decrypting encrypted information C.

FIG. 5 illustrates an exemplary record 500 that represents an encrypted library. In one embodiment, the record 500 includes management information 510 and an encrypted data section 520. Further, the encrypted data section includes a list of application authorization data 530 and an encrypted secret 540.

In one embodiment, the management information 510 facilitates use of the encrypted data section 520, the list of application authorization data 530, and the encrypted secret 540.

In one embodiment, the encrypted data section 520 contains the encrypted information and is not able to be utilized without being identified within the list of application authorization data 530 and without the encrypted secret 540.

In one embodiment, the list of application authorization data 530 includes a listing of multiple target applications. In one embodiment, encrypted information is authorized for each of the target applications represented in the list of application authorization data 520 are authorized to access the information contained within the encrypted data section 530. In one embodiment, the list of application authorization data 530 is compared with the application authorization data that is within the target application. One example of the application authorization data within the target application is shown in the field 420 (FIG. 4).

In one embodiment, the encrypted secret 530 is utilized to decrypt the encrypted information. In one embodiment, the encrypted secret 530 is used to decrypt the encrypted information when the application authorization data 420 from the target application matches the application authorization data 520. In this embodiment, once the encrypted secret 540 is exposed to the target application, the encrypted information is made available to the target application.

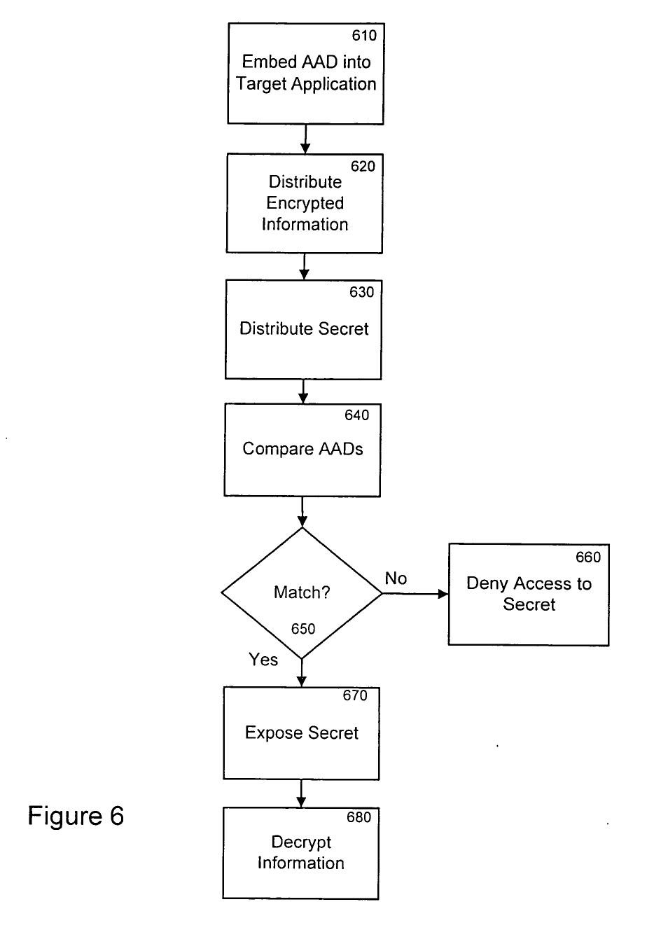

The flow diagram as depicted in FIG. 6 is one embodiment of the methods and apparatuses for utilizing application authorization data. The blocks within the flow diagram can be performed in a different sequence without departing from the spirit of the methods and apparatuses for reviewing general public licenses. Further, blocks can be deleted, added, or combined without departing from the spirit of the methods and apparatuses for utilizing application authorization data.

The flow diagram in FIG. 6 illustrates utilizing application authorization data according to one embodiment of the invention.

In Block 610, the authorization application data is embedded into a target application. In one embodiment, the authorization application data is part of the extended executable and linking format file. Further, the extended executable file is signed and certifies the value of the authorization application data. The signature of the extended executable file also certifies the identity of the entity which signed the file. One example of the authorization application data as part of the extended executable and linking format is shown as the record 400 within FIG. 4.

In one embodiment, specific target applications are selected to embed the authorization application data. The specific target applications are chosen based on these specific target applications requiring access to encrypted information that is associated with authorization application data that matches the embedded authorization application data in the target applications.

In Block 620, encrypted information is distributed to the target application. In one embodiment, the encrypted information is distributed to a plurality of target applications. In another embodiment, the encrypted information is distributed to both authorized and non-authorized target applications.

In one embodiment, the encrypted information includes a library of information. In another embodiment, the encrypted information includes a single document.

In Block 630, an encrypted secret is distributed. In one embodiment, the encrypted secret is distributed to the same target devices that received the encrypted information in the Block 620. In one embodiment, the encrypted secret also includes an encrypted list of authorized application data as shown within the record 500 within FIG. 5. In one embodiment, the encrypted secret is an encrypted symmetric key.

In Block 640, the authorization application data 420 (FIG. 4) embedded in the target application and the authorization application data 530 (FIG. 5) stored with the encrypted secret are compared with each other. In one embodiment, the values for the authorization application data 420 and the authorization application data 530 are compared.

In Block 650, a match between the authorization application data 420 and the authorization application data 530 is checked for.

If there is no match between both authorization application data, then access the encrypted secret is denied in Block 660. In one embodiment, access is denied by failing to decrypt the encrypted secret thereby preventing the target application from accessing the encrypted secret. By denying access to the encrypted secret, the target application is also denied access to the encrypted information that corresponds with the encrypted secret.

If there is a match between both authorization application data, then the encrypted secret is exposed in Block 670. In one embodiment, the encrypted secret is decrypted and exposed to the target application that corresponds with the authorization application data.

In Block 680, encrypted information is decrypted and made available to the target application. In one embodiment, the encrypted information is decrypted through the use of the encrypted secret.

There are different variations on the construction of the authorization application data.

In one embodiment, the authorization application data is represented by a string of characters. In one instance, the authorization application data is an arbitrary string that is reserved for use solely to identify the authorization application data. In one embodiment, this arbitrary string is used in the operating system kernel to determine if the encrypted secret should be exposed to the target application. The encrypted secret is only exposed to target applications with the same authorization application data or the arbitrary string in one embodiment. One benefit of utilizing the arbitrary string as the authorization application data is that multiple target applications can share a single arbitrary string. However, the arbitrary string can be faked or otherwise used by a target application that has a valid signature but is not authorized to utilize the encrypted information.

In another embodiment, the authorization application data is represented by a string of characters and a certificate. In one instance, the authorization application data is an arbitrary string combined with a certificate associated with the signature on the target application. In one embodiment, the encrypted secret has an additional certificate that corresponds with the certificate combined with the arbitrary string. In one embodiment, the kernel determines if the arbitrary string and the certificate contained with the encrypted secret match with the arbitrary string and certificate embedded within the target application.

If there is a match, then the encrypted secret is exposed to the target application. Accordingly, the encrypted information is decrypted by target applications with the same arbitrary string and certificate. Unlike only using the arbitrary string as the authorization application data, the authorization application data with the certificate eliminates the possibility of a valid signature being used with a fake arbitrary string.

In another embodiment, a public key of the certificate is utilized with the encrypted secrete instead of the certificate itself. For example, code snippets associated with the target application and the library (encrypted secret) follow:

Target Application:
[Executable and Linking Format]
[Extended Executable and Linking Format]

[Authorization Application Data *]
...
[Digital Signature + Public Key **]

Library:
[Executable and Linking Format]
[Extended Executable and Linking Format]

[Encryption Section]

[Authorization Application Data 1* + Public Key 1**]
[Authorization Application Data 2* + Public Key 2**]
...
[Authorization Application Data n* + Public Key n**]

...
[Digital Signature + Public Key]

In this embodiment, the [Authorization Application Data *] and [Public Key **] of the target application matches one of the [Authorization Application Data x*+Public Key x**] where “x” is a value between “1” and “n” to reveal the encrypted secret within the library. For example, when the application authorization data and public key of the target application matches one of the authorization application data and public key of the library, then the encrypted secret is used to decrypt the library and allow its use by the application.

Using the public key for verification of the target application is a useful security tool, because the public key is verified by the corresponding private key associated with the target application prior to exposing the encrypted secret within the library.

In yet another embodiment, the authorization application data is represented by a string of characters and a domain. In one instance, the authorization application data is an arbitrary string combined with a domain name embedded within the target application and also with the encrypted secret. For example, the value of the authorization application data with the encrypted secret may be a string in the format of:
domain_name.authorization_phrase

In one embodiment, the “domain name” portion is a valid domain name associated with the application vendor. Accordingly, the domain name matches with the domain name found in the certificate associated with the signature of the target application. The “authorization phrase” can be any string of characters.

In use, the domain name portion of the authorization application data is verified against the certificate owner of the target application. Further, this verification is used to confirm that the digital signature of the target application. If both of the domain names match, then authorization application data is considered valid, and the target application is authorized to access the encrypted secret. If the domain names do not match, then the authorization application data is not considered valid, and the target application is not authorized to access the encrypted secret.

In one embodiment, the domain name is used to prevent one application vendor from using the same authorization application data of a target application from a different vendor. If the domain name is not verified through digital signatures, the second vendor would be able to expose the encrypted secret of the first vendor by utilizing the authorization application data from the first vendor. For example, the second vendor's target application could be used to reveal secrets intended for the target application from the first vendor.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
embedding a first application authorization data within a target application wherein the first application authorization data corresponds with encrypted information;
detecting a second application authorization data; and
comparing the first application authorization data with the second application authorization data; and
selectively decrypting the encrypted information within the target application based on the comparing.

2. The method according to claim 1 further comprising detecting an encrypted secret associated with the second application authorization data.

3. The method according to claim 2 wherein selectively decrypting utilizes the encrypted secret.

4. The method according to claim 1 wherein the first application authorization data is represented by a string.

5. The method according to claim wherein the first application authorization data is represented by a string and a digital certificate.

6. The method according to claim 1 wherein the first application authorization data is represented by a string and a domain name.

7. The method according to claim 1 further comprising utilizing the encrypted information on the target application based on selectively decrypting.

8. The method according to claim 1 wherein the target application is one of a computer, a digital camera, a cellular phone, an audio device, a display device, and an audio/visual device.

9. The method according to claim 1 wherein the first application authorization data corresponds to the target application as a unique device.

10. The method according to claim 1 wherein the first application authorization data corresponds to a plurality of target applications.

11. The method according to claim 1 wherein the encrypted information is a library.

12. A system comprising:
means for embedding a first application authorization data within a target application wherein the first application authorization data corresponds with encrypted information;
means for detecting a second application authorization data; and
means for comparing the first application authorization data with the second application authorization data; and
means for selectively decrypting the encrypted information within the target application based on the comparing.

13. A method comprising:
embedding a first application authorization data within a first group of target applications wherein the first application authorization data corresponds with a first encrypted information;
distributing a second application authorization data among the first group of target applications and a second group of target applications; and
comparing the second application authorization data with the first group of target applications and the second group of target applications; and
selectively decrypting the encrypted information within the first group of target applications based on the comparing.

14. The method according to claim 13 further comprising detecting an encrypted secret associated with the second application authorization data.

15. The method according to claim 14 wherein selectively decrypting utilizes the encrypted secret.

16. The method according to claim 13 wherein the first application authorization data is represented by a string.

17. The method according to claim 13 wherein the first application authorization data is represented by a string and a digital certificate.

18. The method according to claim 13 wherein the first application authorization data is represented by a string and a domain name.

19. The method according to claim 13 further comprising utilizing the encrypted information on the first group of target applications based on selectively decrypting.

20. The method according to claim 1 wherein the first group of target application is a device with a common platform.

21. A system, comprising:
a storage module to store a record containing information regarding an embedded application authorization data;
a target application detection module to detect the embedded application authorization data within a target application; and
a format module to embed the embedded application authorization data within the target application.

22. The system according to claim 21 further comprising an interface module to receive an encrypted secret and a matching application authorization data wherein the embedded application authorization data is configured to be checked against the matching application authorization data.

23. The system according to claim 22 wherein encrypted information is made available to the target application via the encrypted secret when the embedded application authorization data is identical to the matching application authorization data.

24. A computer-readable medium having computer executable instructions for performing a method comprising:
embedding a first application authorization data within a first group of target applications wherein the first application authorization data corresponds with a first encrypted information;
distributing a second application authorization data among the first group of target applications and a second group of target applications; and
comparing the second application authorization data with the first group of target applications and the second group of target applications; and
selectively decrypting the encrypted information within the first group of target applications based on the comparing.
